(19) United States
(12) Patent Application Publication
(10) Pub. No.: US 2006/0147038 A1
(43) Pub. Date: Jul. 6, 2006

(54) Method and installation for controlling a telephone call transmitter on an internet network and telephone terminal therefor

(76) Inventors: Mickael Allain, Lannion (FR); Yacine Zoughlami, Ploumillau (FR); Michel L'Hostis, Plestin les Greves (FR)

Correspondence Address: COHEN, PONTANI, LIEBERMAN & PAVANE, 551 FIFTH AVENUE, SUITE 1210, NEW YORK, NY, 10176, US

(21) Appl. No.: 10/529,989

(22) PCT Filed: Sep. 24, 2003
(86) PCT No.: PCT/FR03/02808

§ 371 Date: Oct. 20, 2005

(30) Foreign Application Priority Data
Oct. 1, 2002 (FR) 0212132

(51) Int. Cl. H04M 1/00

(52) U.S. Cl. 379/457

(57) ABSTRACT

To verify the identity of the sender of a telephone call over an Internet network, there is inserted into a field of a call set-up request frame an encrypted control code containing parameters relating to the identity of a telecommunications terminal from which the telephone call is sent. A remote call management server decrypts the control code. At least one parameter extracted from the decrypted control code is compared with corresponding information stored in a database hosted in the server, and the call is set up as a function of the result of the comparison.

The invention relates to the field of Internet telephony. It applies to all “Voice over IP” (VoIP) protocols, such as the H.323 protocol from the ITU, the Session Initiation Protocol (SIP) from the IETF, and the like, and to all types of domestic or business telephone network architecture.

### BACKGROUND OF THE INVENTION

Internet telephony services conventionally employ mechanisms for authenticating the caller, in particular to prevent calls made by unauthorized third parties being billed to the caller.

These authentication techniques may consist in asymmetrical cryptography encryption mechanisms that exchange a certificate using public and private keys. This technique relies on one-way mathematical functions, i.e. functions that are easy to calculate but extremely difficult to invert. The subscriber holds a private key. He discloses a public key to the party with whom he is communicating. Although the private key of the subscriber and his public key are closely linked, disclosure of the public key does not provide any information regarding the private key. Knowing the subscriber's public key, a remote party can in particular encrypt a message intended for the subscriber.

Another subscriber authentication mechanism is based on the use of an identifier and a password. It is then necessary to give an identifier and a password in order to set up a call. If they are recognized by a call server of the operator, then call set-up is enabled.

The above authentication mechanisms are relatively easy to implement with software telephones. However, the same does not apply to the telephone terminals that are used in Internet Protocol networks, not all of which have the facility for entering a password or for using asymmetrical cryptography encryption.

What is more, to be really effective, asymmetrical cryptography requires a certificate to be obtained from a certified organization, which is hardly compatible with the deployment of a Voice over Internet Protocol service on a very wide scale, to millions of users.

### OBJECTS AND SUMMARY OF THE DRAWINGS

The object of the invention is therefore to alleviate the above drawbacks and to provide a method and an installation for verifying the identity of the sender of a telephone call over an Internet Protocol network that can be used to verify the identity of a sender using a VoIP telephone terminal, i.e. an Internet telephone terminal, and is compatible with expansion of Internet telephony on a very wide scale.

Thus the invention proposes a method of verifying the identity of the sender of a telephone call over an Internet Protocol network, said method comprising the following steps:
inserting into a field of a call set-up request frame an encrypted control code containing parameters relating to the identity of a telecommunications terminal from which the telephone call is sent;
a remote call management server decrypting the control code;
comparing a parameter extracted from the decrypted control code with corresponding information stored in a database hosted in the server; and
setting up the call as a function of the result of said comparison.

According to another feature of the method, it further includes a step of comparing parameters extracted from the decrypted control code with corresponding information extracted from the call set-up request frame.

According to another feature of the method, the information stored in the database includes an address identifying the terminal.

For example, the information is transferred from the terminal to the database during a first call sent by the terminal. The first call may be a call sent immediately after installing the subscriber's telephone terminal.

In one particular embodiment, the parameters extracted from the call set-up request frame include the IP address of the terminal and the calling number of the terminal. Thus the control code can be produced from an encrypted function of the address identifying the terminal and the IP address of the terminal.

The IP address of the terminal is sent by an Internet Protocol network access provider to a verification module associated with the terminal.

In another configuration of the telecommunications network using the method of the invention, the parameters extracted from the call set-up request frame include the IP address of a gateway for connecting a private network to a telecommunications network and the calling number of the terminal.

The control code is then produced from an encrypted function of the address identifying the terminal and the IP address of the gateway.

In this configuration, the IP address of the terminal is sent by an Internet Protocol network access provider to a verification module associated with the gateway.

The invention also proposes an installation for verifying the identity of the sender of a telephone call over an Internet Protocol network, the installation comprising a call management server adapted to cause the setting up of a call between calling and called telecommunications terminals as a function of parameters contained in a call set-up request frame sent by the calling terminal.

The management server includes means for decrypting an encrypted control code inserted into the call set-up request frame and containing parameters relating to the identity of the calling telecommunications terminal and means for comparing a parameter extracted from the control code decrypted by the decrypting means with a corresponding code stored in a database hosted in the server to authorize the setting up of the call as a function of the result of the comparison.

According to another feature of the invention the installation further includes means for comparing parameters extracted from the decrypted control code with corresponding information extracted from the call set-up request frame.

The invention finally proposes a telecommunications terminal for an installation as defined above, said telecommunications terminal including a verification module adapted to insert an encrypted control code into a call set-up request frame.

The verification module includes means for producing an encrypted function of the address identifying the terminal and the IP address of the terminal.

Alternatively, the verification module includes means for producing an encrypted function of the address identifying the terminal and the IP address of a gateway for connecting a local area network to a public telecommunications network.

### BRIEF DESCRIPTION OF THE DRAWINGS

Other objectives, features, and advantages of the invention will become apparent on reading the following description, which is given by way of non-limiting example only and with reference to the appended drawings, in which:

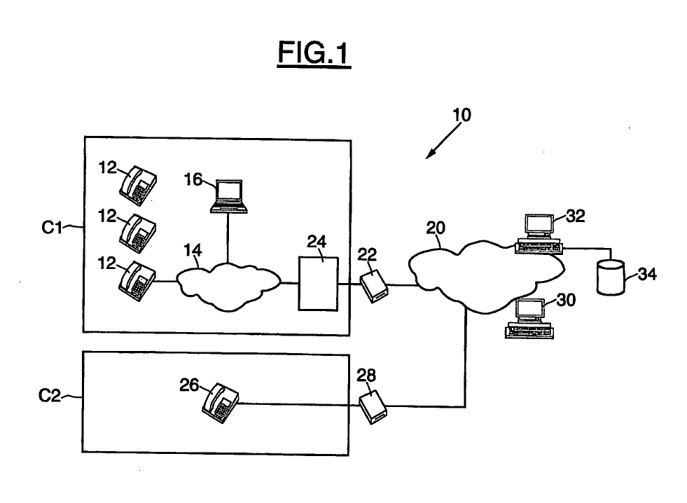

FIG. 1 is a diagram of a telecommunications network structure that provides access to an Internet telephony service and includes an installation using a verification method of the invention to verify the sender of a telephone call;

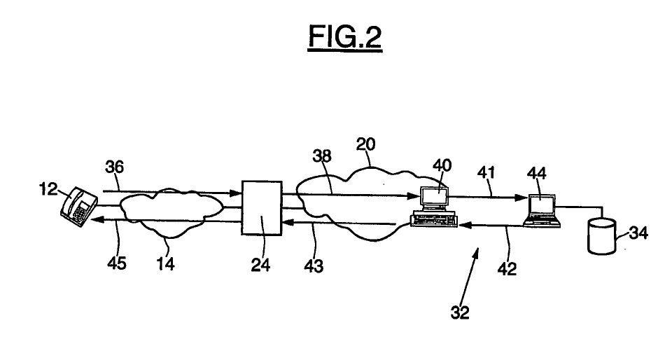

FIG. 2 is a detail view of a portion of the FIG. 1 network, showing a call set-up request sequence; and

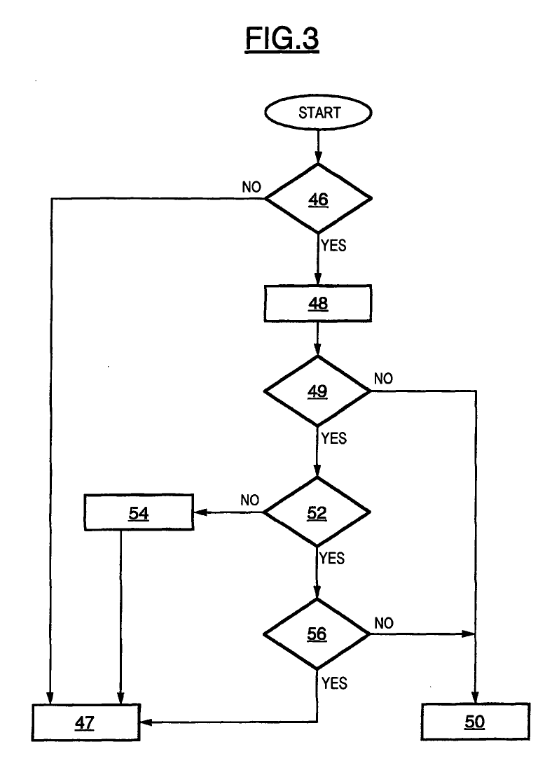

FIG. 3 is a flowchart of the main phases of the verification method of the invention.

### MORE DETAILED DESCRIPTION

FIG. 1 represents the general architecture of a telecommunications network 10 providing access to an Internet telephony service.

This figure shows that the network includes, on the subscriber side, a set of equipments that are used by subscribers to set up telephone calls to remote subscribers.

FIG. 1 shows two different configurations C1 and C2.

The first configuration C1 is based on a private local area network (LAN) 14 and includes a set of telecommunications terminals 12, for example VoIP telephones, connected to the LAN 14. Data processing terminals 16, for example microcomputers, can also be connected to the network 14, as is usual in a private computer network.

Via a modem 22, a gateway 24 interconnects the private network, and in particular the LAN 14, and a public network 20 of a telecommunications operator providing a VoIP telephony service.

The gateway includes a verification module for verifying the identity of the sender of a telephone call, i.e. for verifying that no third party has attempted to misappropriate the calling number of the LAN. This is described in more detail later.

The second configuration C2 corresponds to a subscriber private installation that is particularly suitable for installation in domestic premises, the telephone equipments consisting of telecommunications terminals 26 including an integrated verification module. Each terminal 26 communicates with the public network of the operator 20 via a modem 28.

On the service provider side, the network includes an Internet Protocol network access provider server 30 and a call server 32 which cooperates with the verification modules to verify the identity of the sender of a call and sets up telephone calls for a calling subscriber as a function of the result of verifying the sender and the services configuration offered by the operator.

The call server 32 and the verification module of the gateway (in the configuration C1) or the terminals (in the configuration C2) include all of the hardware and software means for verifying the identity of the sender of a call in order to verify that a subscriber number has not been misappropriated by a third party. This is described in more detail later.

FIG. 1 shows in particular that the call server 32 is associated with a database 34 into which is loaded information relating to subscribers, such as an MAC address identifying the terminal.

As is known in the art, this kind of information is loaded into memory in each terminal 12 during its manufacture. It is transferred into the database 34 under the control of the call server 32 at the time of the first call made from each terminal, i.e. just after installation of a subscriber's terminal.

Furthermore, the Internet Protocol network access provider server 30 sends a public IP address to the verification module of the gateway 24 (or to the terminal 26 if the module is integrated into the terminal) each time that the address concerned is modified.

As is known in the art, in order to set up a VoIP call over the Internet Protocol network 20 from a terminal 12, the terminal produces and then sends to the call server 32 a call set-up request frame. That frame includes a set of fields each conveying information needed for setting up the call, such as the IP address of the calling terminal or the IP address of the gateway and the numbers of the calling and called parties.

To verify that there has been no misappropriation of the calling subscriber's number, the verification module 24 inserts into the call set-up request frame an encrypted message based on the MAC address identifying the terminal and the IP address of the gateway, in the case of the first configuration C1, or of the terminal, in the case of the configuration C2.

As indicated above, the call set-up request frame carries the IP address of the terminal or the gateway in clear (i.e. in unencrypted form). The MAC address identifying the terminal is also stored in the database 34 associated with the call server 32. Accordingly, to verify the identity of the sender of the call, the call server 32 decrypts the control code inserted into the frame, recovers the MAC identification code and the IP address of the gateway or the calling terminal, and then compares, firstly, the MAC address recovered from the frame sent by the calling terminal with the corresponding MAC address stored in the database 34 and, secondly, the IP address obtained by decrypting the control code with the IP address in clear carried by the frame. The call is authorized if the data matches.

The main phases of a call set-up request sequence are described in detail next with reference to FIG. 2, which shows the main components of the network and in which arrows show the flows of data.

As indicated above, the call request begins with a first phase 36 during which the terminal 12 sends to the verification module the call set-up request frame. The verification module sets parameters of a specific field of the control code frame. For example, under the H.323 standard, the verification module 24 inserts into the “h323id” field an encrypted function of the MAC address of the IP telephone and the IP address of the verification module. The frame is then sent to the call server 32 (step 38). Said call server includes a gatekeeper 40 which shares with the verification module a dynamic link library (DLL) that is used to decrypt the control code.

Note that the encryption carried out by the verification module can be any conventional type of encryption. The encryption techniques that can be used in the context of the present disclosure will be evident to the person skilled in the art and are therefore not described in detail here.

Following decryption, firstly, the call management server 32 runs service software 44 (step 41) to verify the sender of the call in order to authorize call set-up if there is a match between the data carried by the control code and the data stored in the database 34, and, secondly, the data in clear carried by the call set-up request frame. The service software then sends the result of this processing to the gatekeeper (step 42). If there has been no attempt at fraud, instructions that authorize a call can then be sent to the verification module (step 43) and to the terminal (step 45).

Referring now to FIG. 3, to verify the identity of the sender of the call, the verification function is itself verified during a first step 46. If the function is inactive, the call is authorized (step 47).

Otherwise, i.e. if the verification function is active, in the next step 48 the call server decrypts the control code, i.e., under the H.323 standard, decrypts the h323id field in order to extract the address identifying the terminal and the IP address of the terminal or the IP address of the gateway. During the next step 49, the call server, and in particular the service software, compares the IP address extracted from the control code with the IP address in clear carried by the call set-up request frame. If those addresses do not match, then the call request is rejected (step 50).

If the IP addresses match, during the next step 52 the call server 32 verifies if the MAC address is in the database.

If the MAC address is not in the database, which reflects the fact that the line has just been set up, the MAC address obtained after decryption is stored in the database (step 54) and the call is authorized.

Nevertheless, if there is a MAC address in the database 34, the call server 32 compares that MAC address with the MAC address obtained by decryption. If the addresses match, the call is authorized (step 47). If not, the call is refused.

Thus the service software verifies that the IP address of the verification module in the call server is correct after decryption. A user, whether a subscriber or not, recovering an IP address of a subscriber to make calls is unable to set up a call because, after the control code has been decrypted, the IP address will not correspond to that of the line used to send the call.

Moreover, the service software verifies that the MAC address of the terminal from which the call was sent matches the MAC address of the terminal stored in the database 34. This verifies that the terminal from which the call attempt is made is the terminal associated with the line.

Thus it is clear that the invention verifies firstly the line and secondly the terminal from which a call is sent.

1. A method of verifying the identity of the sender of a telephone call over an Internet network, said method comprising the following steps:
inserting into a field of a call set-up request frame an encrypted control code containing parameters relating to the identity of a telecommunications terminal from which the telephone call is sent;
a remote call management server decrypting the control code;
comparing at least one parameter extracted from the decrypted control code with corresponding information stored in a database hosted in the server; and
setting up the call as a function of the result of said comparison.

2. A method according to claim 1, further including a step of comparing parameters extracted from the decrypted control code with corresponding information extracted from the call set-up request frame.

3. A method according to claim 1, wherein the information stored in the database includes an address identifying the terminal.

4. A method according to claim 3, wherein said information is transferred from the terminal to the database during a first call sent by the terminal.

5. A method according to claim 2, wherein the information extracted from the call set-up request frame includes the IP address of the terminal and the calling number of the terminal.

6. A method according to claim 1, wherein the control code is produced from an encrypted function of an address identifying the terminal and the IP address of the terminal.

7. A method according to claim 6, wherein the IP address of the terminal is sent by an Internet network access provider to a verification module associated with the terminal.

8. A method according to claim 2, wherein the information extracted from the call set-up request frame include the IP address of a gateway for connecting a private network to a telecommunications network and the calling number of the terminal.

9. A method according to claim 8, wherein the control code is produced from an encrypted function of the address identifying the terminal and the IP address of the gateway.

10. A method according to claim 8, wherein the IP address of the terminal is sent by an Internet network access provider to a verification module associated with the gateway.

11. An installation for verifying the identity of the sender of a telephone call over an Internet network, the installation comprising a call management server adapted to cause the setting up of a call between calling and called telecommunications terminals as a function of parameters contained in a call set-up request frame sent by the calling terminal, wherein the management server includes:
means for decrypting an encrypted control code inserted into the call set-up request frame, the code containing parameters relating to the identity of the calling telecommunications terminal, and
means for comparing at least one parameter extracted from the control code decrypted by the decrypting means with a corresponding code stored in a database hosted in the server to authorize the setting up of the call as a function of the result of the comparison.

12. An installation according to claim 11, further including means for comparing parameters extracted from the decrypted control code with corresponding information extracted from the call set-up request frame.

13. A telecommunications terminal for an installation according to claim 11, said terminal including a verification module adapted to insert an encrypted control code into a call set-up request frame.

14. A terminal according to claim 13, wherein the verification module includes means for producing an encrypted function of the address identifying the terminal and the IP address of the terminal.

15. A terminal according to claim 13, wherein the verification module includes means for producing an encrypted function of the address identifying the terminal and the IP address of a gateway for connecting a local area network to a public telecommunications network.

16. A method according to claim 9, wherein the IP address of the terminal is sent by an Internet network access provider to a verification module associated with the gateway.
